(19) United States
(12) Patent Application Publication
(10) Pub. No.: US 2008/0001942 A1
(43) Pub. Date: Jan. 3, 2008

(54) Power supplying and discharging circuit for liquid crystal display

(75) Inventors: Jia-Hui Tu, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/824,736

(22) Filed: Jul. 2, 2007

(30) Foreign Application Priority Data
Jun. 30, 2006 (TW) 95123840

(51) Int. Cl. G09G 5/00

(52) U.S. Cl. 345/211

(57) ABSTRACT

A power supplying and discharging circuit (20) for a liquid crystal display includes a direct current source (230), a control signal input (210) configured for providing a control signal, a supply-discharge terminal (220) configured for supplying and discharging electricity for the liquid crystal display, an NPN type transistor (240), a PMOS type transistor (250), a bias resistor (255), and a discharging resistor (266). The NPN type transistor includes a base connected to the control signal input, an emitter connected to ground, and a collector connected to the direct current source via the bias resistor. The PMOS type transistor includes a gate electrode connected to the collector of the NPN type transistor, a source electrode connected to the direct current source, and a drain electrode connected to the supply-discharge terminal. The supply-discharge terminal is connected to ground via the discharging resistor.

### FIELD OF THE INVENTION

The present invention relates to power supplying and discharging circuits and, particularly, to a power supplying and discharging circuit for a liquid crystal display.

### GENERAL BACKGROUND

Because liquid crystal displays (LCDs) have the advantages of portability, low power consumption, and low radiation, they have been widely used in various portable information products such as notebooks, personal digital assistants (PDAs), video cameras, and the like. An LCD generally includes a power supplying and a discharging circuit. The power supplying and discharging circuit supplies power when the LCD is turned on, and discharges the electricity when the LCD is turned off.

Referring to FIG. 3, a typical power supplying and discharging circuit 10 is shown. The power supplying and discharging circuit 10 includes a control signal input 110, a supply-discharge terminal (SDT) 120, a first direct current source 130, a second direct current source 140, a first transistor 150, a second transistor 160, a third transistor 170, a first resistor 155, a second resistor 156, a third resistor 165, a fourth resistor 175, and a fifth resistor 176.

The first direct current source 130 is a 12V (volt) direct current source. The second direct current source 140 is a 5V direct current source. The first transistor 150 and the third transistor 170 are NPN (negative-positive-negative) type transistors. The second transistor 160 is an NMOS (N channel metal oxide semiconductor) type transistor.

The base of the first transistor 150 is connected to the control signal input 110 via the first resistor 155. The emitter of the first transistor 150 is connected to the base of the first transistor 150 via the second resistor 156 and is also connected to ground. The collector of the first transistor 150 is connected to the first direct current source 130 via the third resistor 165.

The base of the third transistor 170 is connected to the control signal input 110 via the fourth resistor 175. The emitter of the third transistor 170 is connected to ground. The collector of the third transistor 170 is connected to the SDT 120 via the fifth resistor 176.

The gate electrode of the second transistor 160 is connected to the collector of the first transistor 150. The source electrode of the second transistor 160 is connected to the SDT 120. The drain electrode of the second transistor 160 is connected to the second direct current source 140.

When a low level voltage is applied to the control signal input 110, both the first transistor 150 and the third transistor 170 are turned off. The first direct current source 130 applies a 12V voltage to the gate electrode of the second transistor 160 via the third resistor 165, so that the second transistor 160 is turned on. The second direct current source 140 applies a 5V voltage to the SDT 120 via the on-state second transistor 160, so as to power an LCD panel.

When a high level voltage is applied to the control signal input 110, both the first transistor 150 and the third transistor 170 are turned on. The gate electrode of the second transistor 160 is connected to ground via the on-state first transistor 150. Thereby, the gate electrode of the second transistor 160 has a low level voltage, so that the second transistor 160 is turned off. Then electricity from the SDT 120 is discharged, sequentially through the fifth resistor 176 and the on-state third transistor 170, to ground.

However, the power supplying and discharging circuit 10 requires for the two direct current sources 130, 140. Thus the power supplying and discharging circuit 10 has a complicated layout and is correspondingly costly.

What is needed, therefore, is a new power supplying and discharging circuit that can overcome the above-described deficiencies.

### SUMMARY

In one preferred embodiment of the present invention, a power supplying and discharging circuit for a liquid crystal display includes a direct current source, a control signal input configured for providing a control signal, a supply-discharge terminal configured for supplying and discharging electricity for the liquid crystal display, an NPN type transistor, a PMOS type transistor, a bias resistor, and a discharging resistor. The NPN type transistor includes a base connected to the control signal input, an emitter connected to ground and a collector connected to the direct current source via the bias resistor. The PMOS type transistor includes a gate electrode connected to the collector of the NPN type transistor, a source electrode connected to the direct current source, and a drain electrode connected to the supply-discharge terminal. The supply-discharge terminal is connected to ground via the discharging resistor.

Other novel features and advantages will become more apparent from the following detailed description when taken in conjunction with the accompanying drawings.

### BRIEF DESCRIPTION OF THE DRAWINGS

FIG. 1 is a diagram of a power supplying and discharging circuit for a liquid crystal display according to a first embodiment of the present invention.

FIG. 2 is a diagram of a power supplying and discharging circuit for a liquid crystal display according to a second embodiment of the present invention.

FIG. 3 is a diagram of a conventional power supplying and discharging circuit for a liquid crystal display.

### DETAILED DESCRIPTION OF PREFERRED EMBODIMENTS

Referring to FIG. 1, a power supplying and discharging circuit 20 according to a first embodiment of the present invention is shown. The supplying and discharging circuit 20 is typically employed in an LCD. The supplying and discharging circuit 20 includes a control signal input 210, a supply-discharge terminal (SDT) 220, a direct current source 230, an NPN type transistor 240, and a PMOS (P channel metal oxide semiconductor) type transistor 250, a current limiting resistor 245, a bias resistor 255, and a discharging resistor 266. The control signal input 210 provides a control signal. The control signal can be a high level voltage signal or a low level voltage signal. The direct current source 230 is a 5V direct current source.

The base of the NPN type transistor 240 is connected to the control signal input 210 via the current limiting resistor 245. The emitter of the NPN type transistor 240 is connected to ground. The collector of the NPN type transistor 240 is connected to the direct current source 230 via the bias resistor 255.

The gate electrode of the PMOS type transistor 250 is connected to the collector of the NPN type transistor 240. The source electrode of the PMOS type transistor 250 is connected to the direct current source 230. The drain electrode of the PMOS type transistor 250 is connected to the SDT 220.

The SDT 220 is also connected to ground via the discharging resistor 266.

When a high level voltage is applied to the control signal input 210, the NPN type transistor 240 is turned on. Therefore the gate electrode of the PMOS type transistor 250 is connected to ground via the on-state NPN type transistor 240. The source electrode of the PMOS type transistor 250 is connected to the direct current source 230. Thus Vgs=−5V, wherein Vgs represents a voltage between the gate and the source electrodes of the PMOS type transistor 250, so that the PMOS type transistor 250 is turned on. The direct current source 230 applies a 5V voltage to the SDT 220 via the on-state PMOS type transistor 250 so as to power an LCD panel of the LCD.

When a low level voltage is applied to the control signal input 210, the NPN type transistor 240 is turned off. Thus Vgs=0V, and the PMOS type transistor 250 is turned off. Then electricity from the SDT 220 is discharged through the discharging resistor 266 to ground.

In summary, the power supplying and discharging circuit 20 includes only one direct current source 230. Thus the power supplying and discharging circuit 20 has a simple layout and is correspondingly inexpensive.

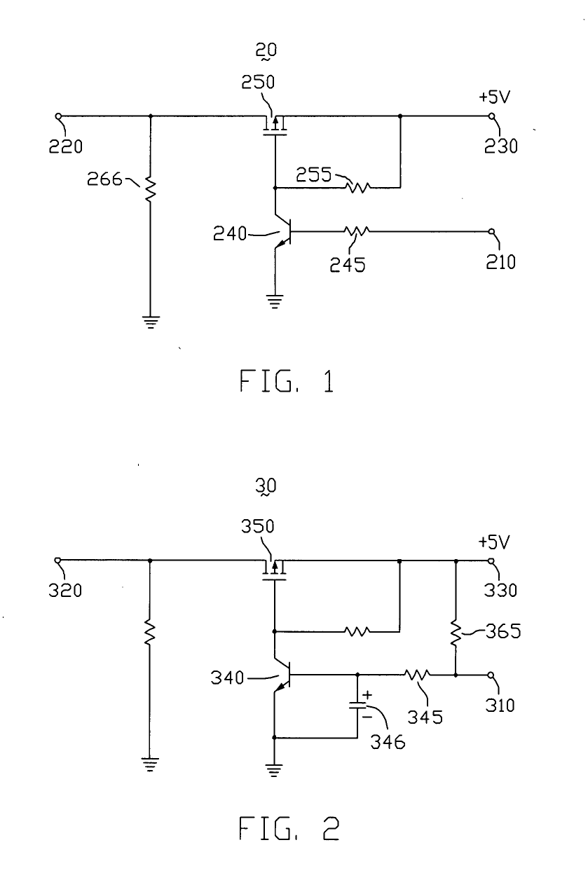

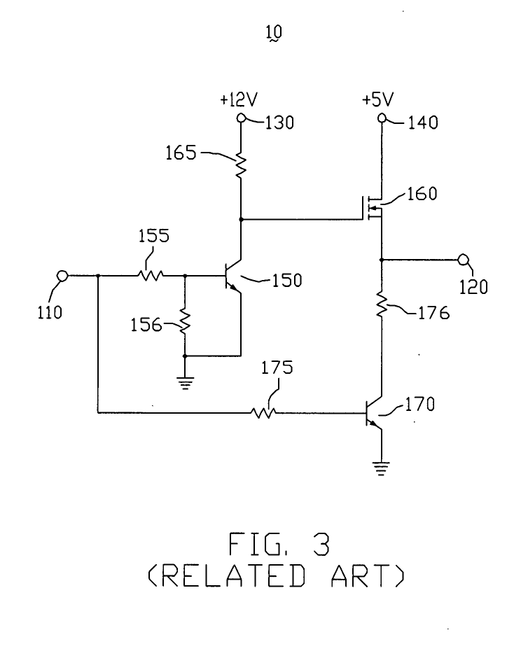

Referring to FIG. 2, a power supplying and discharging circuit 30 according to a second embodiment of the present invention is shown. The supplying and discharging circuit 30 is typically employed in an LCD, and is similar to the power supplying and discharging circuit 20 of the first embodiment. However, the power supplying and discharging circuit 30 further includes a capacitor 346 and a charging resistor 365. The base of an NPN type transistor 340 is connected to ground via the capacitor 346. The charging resistor 365 is connected between a direct current source 330 and a supply-discharge terminal (SDT) 320. The capacitor 346 and a current limiting resistor 345 constitute an RC (resistance-capacitance) integral circuit. The RC integral circuit can prevent an NPN type transistor 340 and a PMOS type transistor 350 from being suddenly turned on, when a control signal applied to a control signal input 310 is suddenly changed from a low level voltage to a high level voltage.

Further or alternative embodiments may include the following. In one example, the NPN type transistor 240 can be replaced by an NMOS type transistor. In such case, the gate electrode of the NMOS type transistor is connected to the current limiting resistor 245. The source electrode of the NMOS type transistor is connected to the PMOS type transistor 250. The drain electrode of the NMOS type transistor is connected to ground. In another example, the PMOS type transistor 250 can be replaced by a PNP (positive-negative-positive) type transistor. The base of the PNP type transistor is connected to the bias resistor 255. The collector of the PNP type transistor is connected to the SDT 220. The emitter of the PNP type transistor is connected to the direct current source 230.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A power supplying and discharging circuit for a liquid crystal display, the power supplying and discharging circuit comprising:
a direct current source;
a control signal input configured for providing a control signal;
a supply-discharge terminal configured for supplying and discharging electricity for the liquid crystal display;
an NPN (negative-positive-negative) type transistor comprising a base connected to the control signal input, an emitter connected to ground, and a collector connected to the direct current source via a bias resistor;
a PMOS (P channel metal oxide semiconductor) type transistor comprising a gate electrode connected to the collector of the NPN type transistor, a source electrode connected to the direct current source, and a drain electrode connected to the supply-discharge terminal; and
a discharging resistor, the supply-discharge terminal being connected to ground via the discharging resistor.

2. The power supplying and discharging circuit of claim 1, further comprising a capacitor, wherein one terminal of the capacitor is connected to the base of the NPN type transistor, and the other terminal of the capacitor is connected to ground.

3. The power supplying and discharging circuit of claim 2, further comprising a charging resistor, wherein the control signal input is connected to the direct current source via the charging resistor.

4. The power supplying and discharging circuit of claim 1, further comprising a current limiting resistor, wherein the base of the NPN type transistor is connected to the control signal input via the current limiting resistor.

5. The power supplying and discharging circuit of claim 1, wherein the direct current source is a 5V direct current source.

6. The power supplying and discharging circuit of claim 1, wherein the control signal is a high level voltage signal or a low level voltage signal.

7. A power supplying and discharging circuit for a liquid crystal display, the power supplying and discharging circuit comprising:
a direct current source;
a control signal input configured for providing a control signal;
a supply-discharge terminal configured for supplying and discharging electricity for the liquid crystal display;
an NMOS (N channel metal oxide semiconductor) type transistor comprising a gate electrode connected to the control signal input, a source electrode connected to ground, and a drain electrode connected to the direct current source via a bias resistor;
a PMOS (P channel metal oxide semiconductor) type transistor comprising a gate electrode connected to the collector of the NPN type transistor, a source electrode connected to the direct current source, and a drain electrode connected to the supply-discharge terminal; and
a discharging resistor, the supply-discharge terminal being connected to ground via the discharging resistor.

8. The power supplying and discharging circuit of claim 7, further comprising a capacitor, wherein one terminal of the capacitor is connected to the gate electrode of the NMOS type transistor, and the other terminal of the capacitor is connected to ground.

9. The power supplying and discharging circuit of claim 8, further comprising a charging resistor, wherein the control signal input is connected to the direct current source via the charging resistor.

10. The power supplying and discharging circuit of claim 7, further comprising a current limiting resistor, wherein the gate electrode of the NMOS type transistor is connected to the control signal input via the current limiting resistor.

11. The power supplying and discharging circuit of claim 7, wherein the direct current source is a 5V direct current source.

12. The power supplying and discharging circuit of claim 7, wherein the control signal is a high level voltage signal or a low level voltage signal.

13. A power supplying and discharging circuit for a liquid crystal display, the power supplying and discharging circuit comprising:
a direct current source;
a control signal input configured for providing a control signal;
a supply-discharge terminal configured for supplying and discharging electricity for the liquid crystal display;
an NPN (negative-positive-negative) type transistor comprising a base connected to the control signal input, an emitter connected to ground, and a collector connected to the direct current source via a bias resistor;
a PNP (positive-negative-positive) type transistor comprising a base connected to the collector of the NPN type transistor, a collector connected to the direct current source, an emitter connected to the supply-discharge terminal; and
a discharging resistor, the supply-discharge terminal being connected to ground via the discharging resistor.

14. The power supplying and discharging circuit of claim 13, further comprising a capacitor, wherein one terminal of the capacitor is connected to the base of the NPN type transistor, and the other terminal of the capacitor is connected to ground.

15. The power supplying and discharging circuit of claim 14, further comprising a charging resistor, wherein the control signal input is connected to the direct current source via the charging resistor.

16. The power supplying and discharging circuit of claim 13, further comprising a current limiting resistor, wherein the base of the NPN type transistor is connected to the control signal input via the current limiting resistor.

17. The power supplying and discharging circuit of claim 13, wherein the direct current source is a 5V direct current source.

18. The power supplying and discharging circuit of claim 13, wherein the control signal is a high level voltage signal or a low level voltage signal.
